(19) United States
(12) Patent Application Publication
(10) Pub. No.: US 2017/0353037 A1
(43) Pub. Date: Dec. 7, 2017

(54) Flexible Variable Speed Genset System

(71) Applicant: Caterpillar Inc., Peoria, IL (US)

(72) Inventor: Suresh Baddam Reddy, Peoria, IL (US)

(73) Assignee: Caterpillar Inc., Peoria, IL (US)

(21) Appl. No.: 15/174,495

(22) Filed: Jun. 6, 2016

(51) Int. Cl. H02J 3/46; H02K 7/18; G05B 15/02

(52) U.S. Cl. CPC H02J 3/46; G05B 15/02; H02K 7/1815

(57) ABSTRACT

A variable speed genset system is provided. The variable speed genset system may include a plurality of gensets, a switch assembly coupling one or more of the gensets to a common bus, a power electronics circuit selectively coupling the switch assembly to the common bus, and a controller in electrical communication with the gensets, the switch assembly and the power electronics circuit. The controller may be configured to designate any one or more of the gensets to operate as variable speed gensets and one or more of the remaining gensets to operate as constant speed gensets, engage the switch assembly to couple the variable speed genset to the power electronics circuit, and engage the switch assembly to couple the constant speed gensets to the common bus.

### TECHNICAL FIELD

The present disclosure relates generally to genset configurations, and more particularly, to systems and methods for controlling variable speed and constant speed gensets.

### BACKGROUND

Genset systems, or networks of engine and generator combination sets, can be used to produce power in a variety of different applications. In marine vessels, for instance, multiple gensets can be harnessed together to drive primary loads, such as propellers or other drive mechanisms, as well as various auxiliary loads, such as heating, ventilation and air conditioning (HVAC) systems, lighting systems, pumps, and the like. In particular, the engine in each genset can be mechanically coupled to the corresponding generator and any mechanically-driven loads, while the generator can be electrically coupled to electrically-driven loads. Different genset configurations may be available for different applications, and selecting the appropriate configuration includes consideration of factors such as load optimization, load distribution, fuel economy, reliability, costs of implementation and maintenance, and the like.

In one configuration, each genset is operated at constant speeds to deliver constant voltage and frequency outputs. Constant speed genset configurations rely on control systems which activate or deactivate individual gensets in order to vary the otherwise constant output. One such configuration is disclosed in U.S. Pub. No. 2014/0309797 (“Frampton”), which discloses constant speed gensets that are controlled by a system that activates or deactivates individual gensets based on the load, fuel efficiency or noise level. Loads may be proportionally shared among active gensets. In other configurations, power demand is apportioned among a plurality of power sources based on performance goals and priorities, such as fuel consumption minimization. While constant speed genset configurations are relatively simple and easily installed, operating each genset at constant speed is not economical in terms of fuel consumption. Furthermore, apart from high noise levels, constant operation at high speeds leads to more wear and maintenance on the genset system. In addition, constant speed genset configurations are prone to uneven loading between gensets with the above described art, which can in turn cause uneven and premature wear within the genset system, if not properly accounted for.

In another configuration, each genset is operated at variable speeds, which in comparison to constant speed gensets, may provide better fuel economy. However, variable speed genset configurations require additional power electronics circuitry coupled to each genset in order to properly convert the variable voltage and frequency outputs to constant voltage with constant frequency for power generation applications. Moreover, it is not only costly to implement power electronics circuitry for each and every genset in the configuration, but it is also costly to maintain the various electronics involved. Also, if only a subset of the gensets are configured to be variable speed gensets, the fuel economy benefits of variable speed operation are reduced by uneven loading of gensets as well as downtime associated with failures and unplanned maintenance. Furthermore, the variable speed genset configurations, as with constant speed genset configurations with various load sharing schemes, are still prone to uneven load distribution, or uneven loading between gensets which can ultimately cause uneven and premature wear within the genset system and also lead to unplanned maintenance or failures. The problem is even more compounded when only one or a subset of gensets are variable speed gensets while others are constant speed gensets. For instance, to gain fuel economy benefits and allow long term even loading of gensets, manual electrical cabling modifications and follow up commissioning checks could be conducted to convert one or more constant speed gensets to variable speed gensets, and vice versa, for one or more variable speed gensets. This, however, negatively impacts operations and can be prone to error with significant failures and maintenance issues.

In view of the foregoing disadvantages associated with conventional genset systems and configurations, a need therefore exists for improved configurations and control schemes, which cost less to implement and maintain, reduce fuel consumption, and improve reliability by more evenly distributing the load over time on the individual gensets, while allowing flexible loading at a given instant. In addition, the configuration may allow for staggering maintenance schedules for gensets by appropriate loading over time. The present disclosure is directed at addressing one or more of the deficiencies and disadvantages set forth above. However, it should be appreciated that the solution of any particular problem is not a limitation on the scope of this disclosure or of the attached claims except to the extent expressly noted.

### SUMMARY OF THE DISCLOSURE

In one aspect of the present disclosure, a variable speed genset system is provided. The variable speed genset system may include a plurality of gensets, a switch assembly coupling one or more of the gensets to a common bus, a power electronics circuit selectively coupling the switch assembly to the common bus, and a controller in electrical communication with the gensets, the switch assembly and the power electronics circuit. The controller may be configured to designate any one or more of the gensets to operate as variable speed gensets and one or more of the remaining gensets to operate as constant speed gensets, engage the switch assembly to couple the variable speed genset to the power electronics circuit, and engage the switch assembly to couple the constant speed gensets to the common bus. An optional energy storage system may also be coupled to the power electronics circuit to couple to the common bus via the switch assembly. The energy storage may be engaged to provide better transient performance as well as provide a mechanism to maintain uninterrupted operation, such as when a constant or designated variable speed genset is shut down and until another genset can be brought on line to couple with the common bus.

In another aspect of the present disclosure, a controller for a plurality of gensets is provided. The controller may include a monitor module configured to monitor one or more operational parameters associated with the gensets, a designation module configured to designate one of the gensets as a variable speed genset and one or more of the remaining gensets as constant speed gensets based on the one or more operational parameters, a switch module configured to output a variable frequency output from the variable speed genset and one or more constant frequency outputs from the constant speed gensets, and a converter module configured to convert the variable frequency output into a converted constant frequency output.

In yet another aspect of the present disclosure, a method of controlling a plurality of gensets is provided. The method may include monitoring one or more operational parameters associated with the gensets, designating one of the gensets as a variable speed genset and one or more of the remaining gensets as constant speed gensets based on the one or more operational parameters, coupling the variable speed genset to a power electronics circuit, and coupling the constant speed gensets to a common bus.

These and other aspects and features will be more readily understood when reading the following detailed description in conjunction with the accompanying drawings.

### BRIEF DESCRIPTION OF THE DRAWINGS

FIG. 1 is a partial perspective view of a marine vessel having a variable speed genset system constructed in accordance with the teachings of the present disclosure;

FIG. 2 is a diagrammatic view of one exemplary embodiment of a variable speed genset system;

FIG. 3 is a diagrammatic view of another exemplary embodiment of a variable speed genset system;

FIG. 4 is a diagrammatic view of one exemplary controller of a variable speed genset system; and

FIG. 5 is a flow diagram of one exemplary algorithm or method of controlling a variable speed genset system.

While the following detailed description is given with respect to certain illustrative embodiments, it is to be understood that such embodiments are not to be construed as limiting, but rather the present disclosure is entitled to a scope of protection consistent with all embodiments, modifications, alternative constructions, and equivalents thereto.

### DETAILED DESCRIPTION

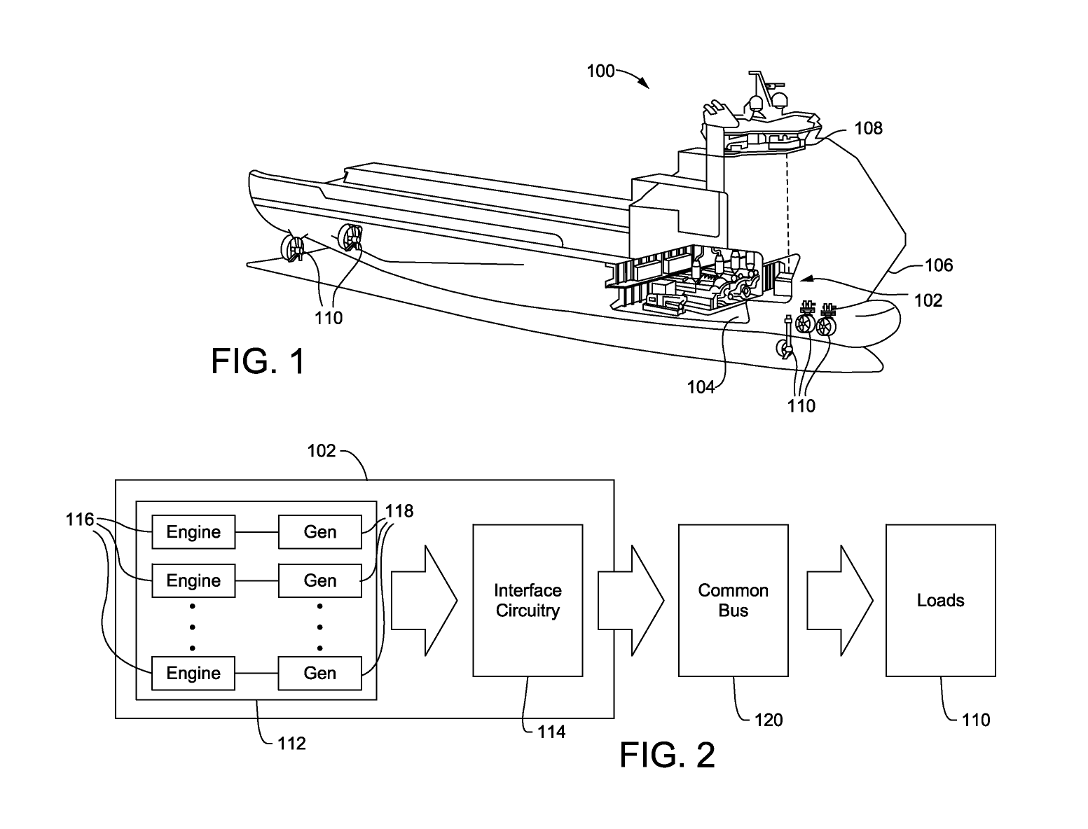

Referring to FIG. 1, one exemplary machine 100, such as a marine vessel, having a variable speed genset system 102 is provided. In the particular machine 100 shown in FIG. 1, for example, the variable speed genset system 102 may be anchored to a platform 104 within a hull 106 of the machine 100, and at least partially controlled from a bridge 108 or any other suitable location onboard and/or offboard the machine 100. Moreover, the variable speed genset system 102 may be used to supply power to one or more loads 110 of the machine 100. For example, the loads 110 may include any number of devices that consume mechanical and/or electrical power, such as motors for powering propellers or other drive mechanisms, lighting systems, heating, ventilation and air conditioning (HVAC) systems, water pumps, and any other primary or auxiliary load of the machine 100.

Although the machine 100 shown in FIG. 1 is depicted as a marine vessel, it will be understood that the machine 100 may include other types of mobile and/or stationary machines, such as machines typically used in mining, construction, farming, transportation, and other industries, or mobile or stationary power generation equipment used in many industries. Aside from marine vessels, for instance, the machine 100 may include an earth moving machine, an aircraft, a tractor, an off-road truck, an on-highway truck or passenger vehicle, a genset system for an oil drilling site or a power generation installation for a remote area or the like. Moreover, while the machine 100 in FIG. 1 includes a variable speed genset system 102 that is configured to supply power to loads 110 which include propellers, it will be understood that the variable speed genset system 102 in other types of machines 100 may similarly be used to supply power to wheels, tracks, and/or any other drive and propulsion mechanisms.

Turning to FIG. 2, one exemplary embodiment of the variable speed genset system 102 that may be used with the machine 100 of FIG. 1 is provided. In general, the variable speed genset system 102 may include a plurality of gensets 112 and interface circuitry 114 for electrically coupling the gensets 112 to the loads 110 of the machine 100. As shown, each genset 112 may include an engine 116 that is mechanically coupled to a generator 118. The engine 116 may include a diesel engine, a gasoline engine, a natural gas engine, or any other type of combustion engine capable of mechanically driving or rotating the generator 118. Moreover, as an added benefit to the variable speed genset system 102 shown, the individual engines 116 need not be similarly sized and can have varying load capacities. The generator 118 may include any suitable electric generator that can generate electrical energy, such as multi-phase alternating current (AC) voltage, using the mechanical energy supplied by the engine 116. For instance, the generator 118 may include an electrically-excited brushless synchronous generator, an electrically-excited brush type synchronous generator, a permanent magnet generator, an induction generator, or the like.

Furthermore, the interface circuitry 114 of FIG. 2 may receive the electrical energy supplied by each of the gensets 112, condition and/or convert the electrical energy into a form more suitable for the loads 110, such as constant frequency and constant alternating current (AC) voltage, and communicate the electrical energy to a common bus 120 associated with the machine 100. More specifically, the common bus 120 may be used to communicate the electrical energy to the various loads 110 of the machine 100. Additionally or optionally, an energy storage device 122, such as batteries, ultracapacitors, and the like, may be coupled to the interface circuitry 114. In other embodiments, the common bus 120 may additionally incorporate one or more energy storage devices 112 within which the common bus 120 can store excess energy for later use. Depending on the type of loads 110 present, the common bus 120 may also incorporate additional circuitry, such as inverters, converters, rectifiers, filters, and the like, that may be used to convert the electrical energy in the common bus 120 into forms more suited for the individual loads 110.

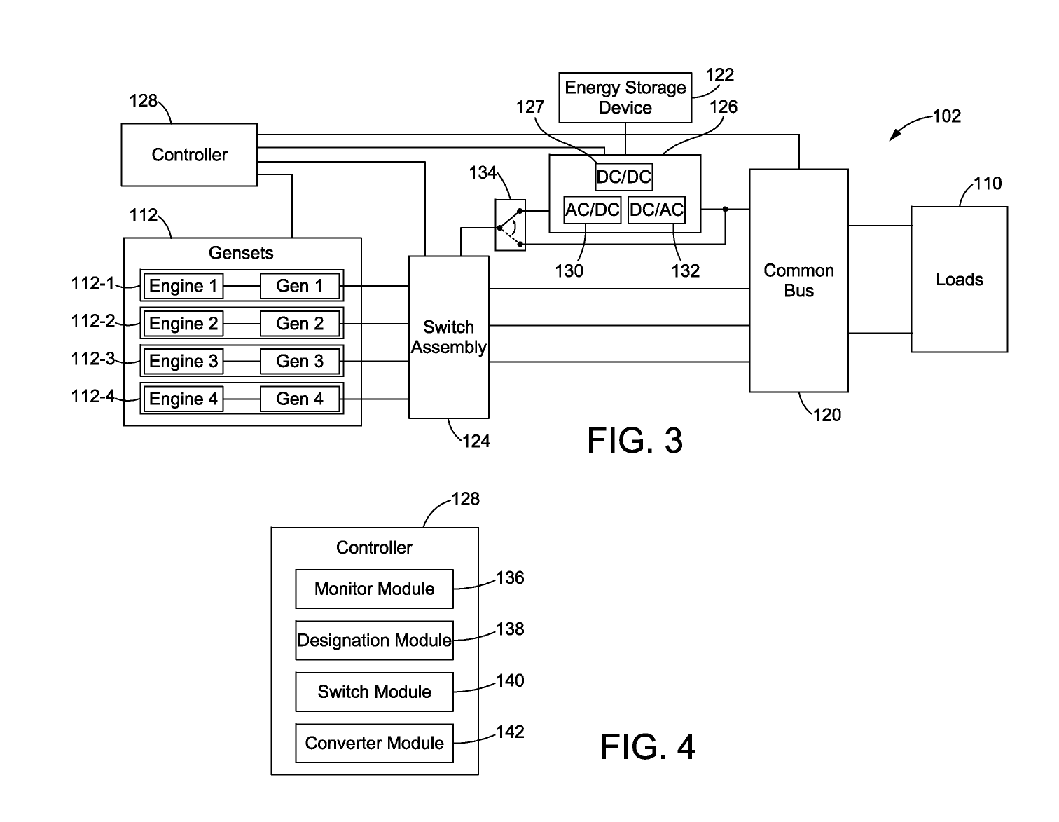

Referring now to FIG. 3, another exemplary embodiment of the variable speed genset system 102 is provided in more detail. As shown, the variable speed genset system 102 may generally include a plurality of gensets 112, a switch assembly 124, a power electronics circuit 126, and a controller 128. In particular, each genset 112 may include an engine 116 and a generator 118 mechanically coupled thereto. The switch assembly 124 may electrically couple one or more of the outputs of the gensets 112 to one or more loads 110 of the machine 100 via the common bus 120, or the like. Furthermore, the power electronics circuit 126 may be electrically and selectively coupled between the switch assembly 124 and the common bus 120. Still further, the controller 128 may be in electrical communication with and operatively coupled to one or more of the gensets 112, the switch assembly 124 and the power electronics circuit 126. Furthermore, the power electronics circuit 126 may be coupled to the energy storage device 122.

Still referring to FIG. 3, each genset 112 may include an engine 116 and a generator 118 mechanically coupled thereto. Furthermore, each engine 116 and thus each genset 112 may be operated in either a variable speed mode or a constant speed mode of operation. Moreover, one of the gensets 112 may be designated to operate as a variable speed genset and electrical output having variable frequency and possibly variable voltage, while the remaining gensets 112 are designated to operate as constant speed gensets and output electrical signals having constant frequency and constant voltage. As will be discussed in more detail further below, the mode of operation of each genset 112 may be designated via instructions electrically communicated from the controller 128, and determined based on a variety of factors, such as operational parameters of the machine 100 and/or preprogrammed or real-time optimized profiles configured to optimize fuel consumption, load distribution, and the like. Furthermore, the designation of the ] gensets 112 may be performed in real-time and automatically during operation.

The switch assembly 124 of FIG. 3 may be electrically coupled to each of the outputs of the gensets 112, and configured to connect or disconnect each of the gensets 112 to the common bus 120. In addition, the switch assembly 124 can be configured to connect one of the gensets of 112 operating in variable speed mode to the power electronics circuit 126 while passing through the remaining gensets 112 operating in constant speed mode directly to the common bus 120. In addition, the switch assembly 124 may include switches that engage or disengage each genset from the common bus 120. For instance, the switch assembly 124 may use interlocking switches, or any other switch arrangement, that is engageable by the controller 128 and capable of selectively switching any one of the gensets 112 to the power electronics circuit 126. The power electronics circuit 126 may include an AC to DC converter 130, for example, a DC link with a capacitor, a DC to AC converter 132, and/or any other circuitry such as filters, inductors, configured to convert the variable frequency and/or variable voltage output by one of the gensets 112 into a constant frequency and/or constant voltage signal appropriate for the connected loads 110. For instance, the AC to DC converter 130 may include an active front end, a diode rectifier, such as 6-pulse, 12-pulse, 18-pulse, 24-pulse rectifier, or the like, a phase controller rectifier, a diode rectifier followed by a chopper, and any other circuitry suited to the generator type and its characteristics as well as the choice of power electronics technology. Ultimately then, the common bus 120 may receive a plurality of constant frequency and/or constant voltage inputs from the switch assembly 124 and the power electronics circuit 126.

Optionally or additionally, the switch assembly 124 of FIG. 3 may include a bypass switch 134 electrically coupling the variable frequency output of the switch assembly 124 to either the power electronics circuit 126 or the common bus 120. More particularly, the bypass switch 134 may be used to enable the output of the designated variable speed genset 112 to pass straight through to the common bus 120 during instances when the power electronics circuit 126 is not needed, but otherwise couple the designated variable speed genset 112 to the power electronics circuit 126. The power electronics circuit 126 may not be needed, for instance, when the genset 112, although operating in a variable speed mode, is operating at a substantially constant operating speed, such as a maximum operating speed, or where the output signal is effectively a constant frequency and/or constant voltage signal without being passed through the power electronics circuit 126. The bypass switch 134 may include a contactor, a motor-actuated selector switch, or any other suitable means for enabling a controllable switch.

In such cases, the bypass switch 134 may directly couple the designated variable speed genset 112 to the common bus 120, and thereby reduce unnecessary losses from the power electronics circuit 126. Furthermore, because the bypass switch 134 can relieve the power electronics circuit 126 from the higher loads associated with maximum operating speeds, the maximum load capacity of the power electronics circuit 126 as well as the costs associated therewith may be reduced. Although the variable speed genset system 102 in FIG. 3 is depicted with one possible switch arrangement, it will be understood that other switch arrangements may be used to provide comparable results. For instance, any one or more of the switch assembly 124 and the power electronics circuit 126 may be automatically implemented, manually implemented, or any combination thereof. Moreover, any one or more of the connections between the gensets 112 and common bus 120 may be automatically and/or manually switched or engaged. Still further, the power electronics circuit 126 may include optional or additional circuitry, such as a DC to DC converter 127 and any supporting circuitries including inductors, fuses, contactors, and the like, configured to convert DC voltage from the optional energy storage device 122, for example, batteries and ultracapacitors, into a DC link voltage that is appropriate for interfacing with the DC link between the power electronics circuit 126 and the common bus 120, and ultimately converted via the DC to AC converter 132 into AC output for coupling with the common bus 120.

Although the variable speed genset system 102 of FIG. 3 is shown with four gensets 112, it will be understood that the variable speed genset system 102 may include fewer or more gensets 112. Furthermore, the switch assembly 124 may be correspondingly configured to selectively couple more than one genset 112 to the power electronics circuit 126 while passing the outputs of the remaining gensets 112 directly through to the common bus 120. This may be accomplished by operating all of the variable speed gensets 112 to run at substantially the same speed, producing similar output voltages, and employing the controller 128 for paralleling and synchronization of outputs. Additionally, while the embodiment of FIG. 3 is shown with one power electronics circuit 126 coupled to the common bus 120, other embodiments may include additional power electronics circuits 126 coupled to the common bus 120, so long as the total number of power electronics circuits 126 does not exceed the total number of gensets 112 available. Furthermore, in configurations having more than one power electronics circuit 126, the switch assembly 124 may be correspondingly configured to selectively couple more than one genset 112 to the power electronics circuits 126 while passing the outputs of the remaining gensets 112 directly through to the common bus 120.

Turning to FIG. 4, one exemplary embodiment of a controller 128 that may be used in association with the variable speed genset system 102 is diagrammatically provided. The controller 128 may be implemented using one or more of a processor, a microprocessor, a microcontroller, an electronic control module (ECM), an electronic control unit (ECU), and any other suitable device for operatively communicating with one or more of the gensets 112, interface circuitry 114, engines 116, generators 118, common bus 120, switch assembly 124, power electronics circuit 126, and the like. The controller 128 may be configured to operate according to predetermined algorithms or sets of instructions designed to control the variable speed genset system 102 and the gensets 112 thereof in an efficient and reliable manner. For example, the controller 128 may determine an optimum mode of operation based on a set of performance goals, priorities and constraints using the operational parameters of the gensets 112 and/or the machine 100, and according to fuel and/or load optimization maps or profiles preprogrammed therein.

Still referring to FIG. 4, the controller 128 may be configured to function according to one or more preprogrammed algorithms, which may be generally categorized into, for example, a monitor module 136, a designation module 138, a switch module 140, and a converter module 142. The controller 128 may also include the functions of paralleling and synchronizing the outputs of the constant speed gensets 112 in as well as the outputs of the variable speed genset 112 via the power electronics circuit 126 coupled to the common bus 120. The controller 128 may also be configured to include paralleling and synchronization of a plurality of variable speed gensets 112 from running at substantially the same speed producing similar voltages to the power electronics circuit 126, if such a configuration is desired. In addition, the controller 128 may also decide the distribution of loading among gensets 112 based on any operational constraints and performance goals, such as fuel economy and long term load distribution among gensets 112.

The monitor module 136 may be configured to monitor one or more operational parameters of the gensets 112 and/or the machine 100. The monitor module 136 may receive or detect feedback from the gensets 112 and the machine 100 using sensor systems commonly used in the art, and monitor operational parameters, such as engine operating speeds, runtime, load capacity, load duty cycles, fuel consumption rates, fuel economy, and any other relevant information. Additionally, the operational parameters may be individualized and specific to each genset 112 or engine 116 within the variable speed genset system 102. Furthermore, the monitor module 136 may have access to, or have the ability to make updates or additions to, historical data previously logged for each individual genset 112 or engine 116.

In turn, the designation module 138 of FIG. 4 may be configured to designate one or more of the gensets 112 as variable speed gensets, and designate the remaining gensets 112 as constant speed gensets based on one or more of the operational parameters provided by the monitor module 136. For instance, the designation module 138 may cause one of the gensets 112 in FIG. 3 to operate in a variable speed mode, and operate the remaining three gensets 112 to operate in a constant speed mode based on a comparison between the operational parameters and preprogrammed optimization profiles. Among other things, a fuel optimization profile may indicate optimum engine operating speeds for a particular load and a target fuel consumption rate. The load optimization profile may indicate the relative loading or runtime histories for each of the individual gensets 112, which allows the designation module 138 to avoid overloading one genset 112 over another. The designation module 138 can thereby promote more even distribution of load between the gensets 112, and help extend the life of the variable speed genset system 102. Furthermore, the designation module 138 may perform such designations in real-time and automatically during operation.

Based on the designations made by the designation module 138, the switch module 140 of FIG. 4 may be configured to output a variable frequency signal or output from the designated variable speed genset 112 and one or more constant frequency signals or outputs from the designated constant speed gensets 112. For instance, consider the goal to provide more even loading among the gensets 112 over time, while optimizing fuel economy throughout and if the designation module 138 determines that the second genset 112-2 in FIG. 3 historically has the least amount of running hours than the other gensets 112-1, 112-3 and 112-4, the designation module 138 may assign that genset 112-2 to operate in a variable speed mode for at least the given iteration and allow it to be among the first active and loaded gensets 112, and assign each of the other gensets 112-1, 112-3 and 112-4 to operate in a constant speed mode with a lower loading priority until changes in the conditions or operational parameters suggest otherwise. Based on those designations, the switch module 140 may control or engage the switch assembly 124 to connect the output of the designated variable speed genset 112-2 to the power electronics circuit 126, and to pass through the outputs of the designated constant speed gensets 112-1, 112-3 and 112-4 directly to the common bus 120.

Correspondingly, the converter module 142 of FIG. 4 may be configured to convert the variable frequency signal or output, originally supplied by the designated variable speed genset 112-2 and output by the switch assembly 124, into a converted constant frequency signal or output. For example, the converter module 142 may be adapted to control the power electronics circuit 126 of FIG. 3 to convert the variable frequency and/or variable voltage signal into a constant frequency and/or constant voltage signal that is appropriate for the common bus 120 or the loads 110 connected thereto. Additionally, the converter module 142 may disable the power electronic circuit 126, or the switch module 140 may simply engage the bypass switch 134 of FIG. 3, when conversions are not necessary, such as when the designated variable speed genset 112-2, although operating in a variable speed mode, outputs a signal that is effectively a constant frequency and/or constant voltage signal without being passed through the power electronics circuit 126. In addition, the converter module 142 may charge and/or discharge the optional energy storage device 122 via the DC to DC converter 127 so as to enable the energy storage device 122 to maintain uninterrupted power through the DC link of the power electronics circuit 126 during transient events, or planned or unplanned shutdown events.

### INDUSTRIAL APPLICABILITY

In general, the present disclosure finds utility in marine applications, but can also find utility in various other applications, such as in mining, construction, farming, transportation, and other industries. More particularly, the present disclosure provides a simple and cost-effective solution for operating multiple gensets in an efficient and reliable manner. For instance, by enabling one or more gensets to partially operate in variable speed modes as necessary, the present disclosure improves overall fuel economy. Also, by providing the ability to designate different variable speed gensets based on loading or runtime, the present disclosure is able to more appropriately distribute the load among the gensets over time to allow for proper maintenance without downtime as well as prolong the life of the genset system. Still further, by requiring as few as one power electronics circuit, the present disclosure also reduces implementation and maintenance costs typical of conventional constant speed genset configurations.

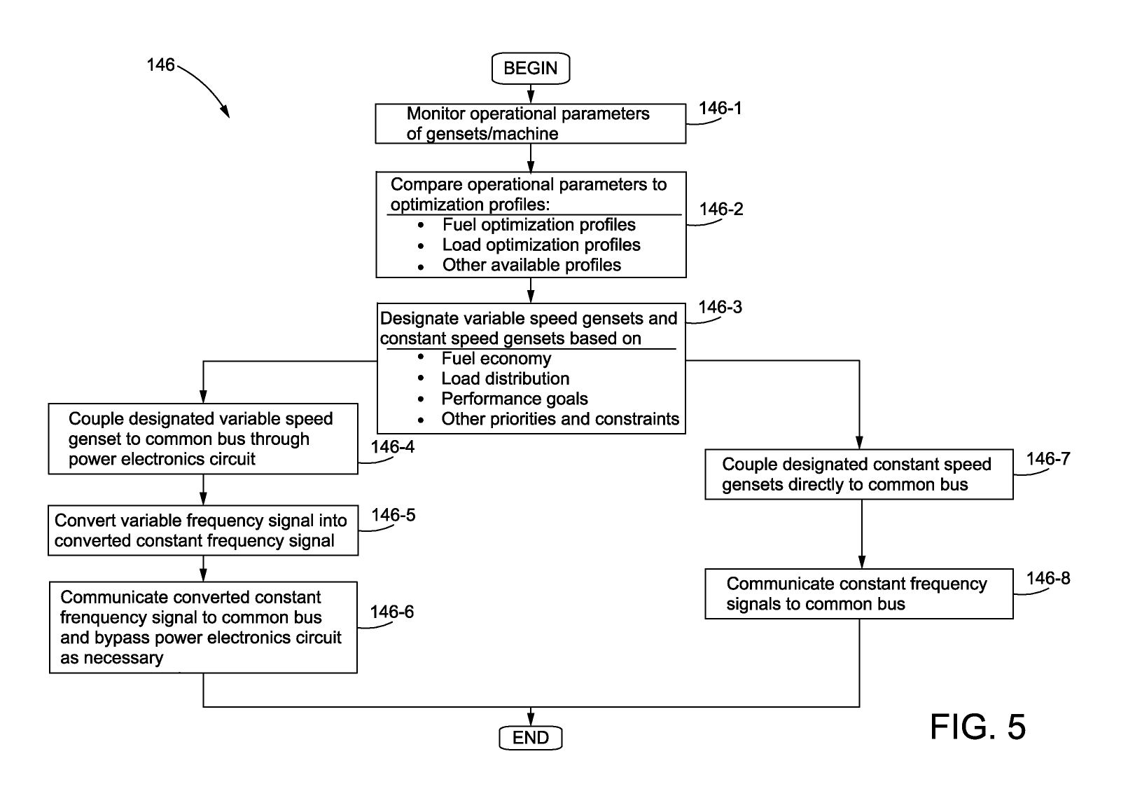

Turning now to FIG. 5, one exemplary algorithm or method 146 for controlling the variable speed genset system 102 is provided. In particular, the method 146 may be implemented in the form of one or more algorithms, instructions, logic operations, or the like, and the individual processes thereof may be performed or initiated via the controller 128. Although the method 146 may be substantially automated, it will be understood that certain portions of the method 146 may also be amenable to be performed manually. As shown in block 146-1, the method 146 may initially monitor operational parameters of the individual gensets 112 and/or the machine 100. For example, the method 146 may receive, detect and monitor operational parameters, such as engine operating speeds, runtime, load capacity, load duty cycles, fuel consumption rates, fuel economy, and any other relevant information. While receiving new operational parameters, the method 146 may additionally access, update and/or make additions to historical data previously logged for each genset 112.

According to block 146-2 of FIG. 5, the method 146 may further compare the operational parameters to one or more preprogrammed optimization profiles. For example, the method 146 may compare the operational parameters to a fuel optimization profile, a load optimization profile, and/or any other profile provided as a reference by which the gensets 112 can be controlled. Moreover, a fuel optimization profile may indicate optimum engine operating speeds for a particular load and a target fuel consumption rate, while a load optimization profile may indicate the relative loading or runtime histories for each of the individual gensets 112. Based on the comparisons, the method 146 in block 146-3 may be configured to designate which gensets to be in operation, and have one of the gensets 112 to operate in a variable speed mode, and further, designate each of the remaining gensets 112 that are designated to operate, to operate in a constant speed mode, and as well as apportionment of the loads among these gensets, based on performance goals, priorities such as fuel economy, load distribution as well as operating constraints for the gensets. In FIG. 3, for instance, if the operational parameters indicate that the runtime of the second genset 112-2 is significantly below the runtimes of the other three gensets 112-1, 112-3 and 112-4, the method 146 may designate the second genset 112-2 to operate in a variable speed mode as well as designate it to be among the first gensets to be operational and loaded.

Based on the designations, the method 146 in block 146-4 of FIG. 5 may be configured to engage a switch assembly 124 to couple the output of the genset 112 operating in a variable speed mode through a power electronics circuit 126 as shown in FIG. 3. Using the power electronics circuit 126, the method 146 in block 146-5 may in turn convert the variable frequency output by the genset 112 into a converted constant frequency output. For example, the power electronics circuit 126 may be controlled in a manner which outputs a converted constant frequency output that is appropriate for the common bus 120 and any connected loads 110. The method 146 in block 146-6 may further communicate the converted constant frequency output to a common bus 120. Additionally or optionally, the method 146 may selectively bypass the power electronics circuit 126, such as via control of the bypass switch 134 of FIG. 3, when conversions are not necessary to reduce the losses from the power electronics circuit 126.

Still referring to FIG. 5, the method 146 in block 146-7 may be configured to couple the gensets 112 operating in a constant speed mode directly to the common bus 120. As shown in FIG. 3, for example, the method 146 may be configured to engage the switch assembly 124 such that the outputs of the gensets 112 are connected directly to the common bus 120, while the output of the genset 112 operating in a variable speed mode is connected to the power electronics circuit 126. Furthermore, the method 146 in block 146-8 may be configured to communicate the constant frequency outputs directly to the common bus 120 without substantial power conversions. Although the method 146 in FIG. 5 designates one genset 112 to operate in a variable speed mode, in other embodiments or modifications, the method 146 may designate more than one of the gensets 112 to operate in a variable speed mode, so long as either the variable speed gensets 112 are paralleled and synchronized by the controller 128 while operating at substantially the same speed to an appropriate power electronics circuit 126 or a separate power electronics circuit 126 is available for each such genset 112 operating in a variable speed mode.

In addition, the method 146 of FIG. 5 may maintain any designations for one or more iterations, or at least until the operational parameters indicate changes in the gensets 112 and/or the machine 100 urge otherwise. For instance, if the operational parameters indicate that the runtime of a genset 112 previously operating in a variable speed mode significantly exceeds all of the runtimes of gensets 112 previously operating in a constant speed mode, the method 146 may reassign the gensets 112 in a subsequent iteration. In the next iteration, for example, the genset 112 which previously operated in a variable speed mode may be reassigned to operate in a constant speed mode, while one of the gensets 112 which previously operated in a constant speed mode is reassigned to operate in a variable speed mode. Such reassignments may be made based on changes in fuel economy, load distribution, load optimization guidelines and other changes.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A variable speed genset system, comprising:
a plurality of gensets;
a switch assembly coupling one or more of the gensets to a common bus;
a power electronics circuit selectively coupling the switch assembly to the common bus; and
a controller in electrical communication with the gensets, the switch assembly and the power electronics circuit, the controller being configured to designate any one or more of the gensets to operate as variable speed gensets and one or more of the remaining gensets to operate as constant speed gensets, engage the switch assembly to couple the variable speed genset to the power electronics circuit, and engage the switch assembly to couple the constant speed gensets to the common bus.

2. The variable speed genset system of claim 1, wherein the designation of the variable speed gensets and the constant speed gensets are performed in real-time and automatically during operation.

3. The variable speed genset system of claim 1, wherein each genset includes an engine mechanically coupled to a generator, the switch assembly being electrically coupled to an output of each generator, each genset being selectively operable in one of a constant speed mode and a variable speed mode.

4. The variable speed genset system of claim 1, wherein the switch assembly includes an interlocked switch for coupling the variable speed genset to the power electronics circuit and passing through the constant speed gensets.

5. The variable speed genset system of claim 1, wherein the switch assembly is configured to selectively couple the variable speed genset to the power electronics circuit, and selectively couple the constant speed gensets to the common bus, the switch assembly including a bypass switch configured to selectively couple the variable speed genset to one of the power electronics circuit and the common bus.

6. The variable speed genset system of claim 1, further comprising an energy storage device coupled to the power electronics circuit and configured to maintain uninterrupted power during transient events.

7. The variable speed genset system of claim 1, wherein the power electronics circuit is configured to receive a variable frequency output generated by the variable speed genset through the switch assembly, and convert the variable frequency output into a converted constant frequency output.

8. The variable speed genset system of claim 1, wherein the controller is configured to monitor one or more operational parameters associated with the gensets, and designate the variable speed genset and the constant speed gensets and apportion loads based on a comparison between the operational parameters and one or more of a fuel optimization profile, a load optimization profile, performance goals, priorities, and constraints.

9. A controller for a plurality of gensets, comprising:
a monitor module configured to monitor one or more operational parameters associated with the gensets;
a designation module configured to designate one of the gensets as a variable speed genset and one or more of the remaining gensets as constant speed gensets based on the one or more operational parameters;
a switch module configured to output a variable frequency output from the variable speed genset and one or more constant frequency outputs from the constant speed gensets; and
a converter module configured to convert the variable frequency output into a converted constant frequency output.

10. The controller of claim 9, wherein the designation module is configured to designate the variable speed genset and the constant speed gensets based on a comparison between the one or more operational parameters and one or more of a fuel optimization profile and a load optimization profile, performance goals, priorities, and constraints.

11. The controller of claim 9, wherein the designation module is configured to conduct paralleling and synchronization of the constant speed gensets and the variable speed genset.

12. The controller of claim 9, wherein the designation module is configured to conduct paralleling and synchronization of a plurality of variable speed gensets.

13. The controller of claim 9, wherein the switch module is configured to output the variable frequency output to a power electronics circuit and output the constant frequency outputs to a common bus.

14. The controller of claim 13, wherein the converter module is configured to convert the variable frequency output into the converted constant frequency output using the power electronics circuit, and the switch module is configured to selectively enable the variable frequency output to bypass the power electronics circuit using a bypass switch.

15. A method of controlling a plurality of gensets, comprising:
monitoring one or more operational parameters associated with the gensets;
designating one of the gensets as a variable speed genset and one or more of the remaining gensets as constant speed gensets based on the one or more operational parameters;
coupling the variable speed genset to a power electronics circuit; and
coupling the constant speed gensets to a common bus.

16. The method of claim 15, wherein the variable speed genset and the constant speed gensets are designated based on a comparison between the one or more operational parameters and one or more of a fuel optimization profile and a load optimization profile.

17. The method of claim 15, wherein the variable speed genset is coupled to the power electronics circuit and the constant speed gensets are coupled to the common bus using control of a switch assembly, the switch assembly being configured to selectively enable communication between the variable speed genset and the power electronics circuit, and selectively enable communication between the constant speed gensets and the common bus.

18. The method of claim 17, wherein the switch assembly includes a bypass switch configured to selectively couple the variable speed genset to one of the power electronics circuit and the common bus.

19. The method of claim 15, further comprising:
converting a variable frequency output generated by the variable speed genset into a converted constant frequency output using the power electronics circuit; and
coupling the converted constant frequency output to the common bus.

20. The method of claim 19, further comprising:
coupling each of the converted constant frequency output and the one or more constant frequency outputs to the common bus associated with the gensets.
